(19) United States
(12) Patent Application Publication
(10) Pub. No.: US 2008/0246471 A1
(43) Pub. Date: Oct. 9, 2008

(54) Magnetic Sensor Device With Different Internal Operating Frequencies

(75) Inventors: Josephus Arnoldus Henricus Maria Kahlman, Tilburg (NL); Jeroen Veen, Nijmegen (NL); Bart Michiel De Boer, Den Bosch (NL); Theodorus Petrus Henricus Gerardus Jansen, Deurne (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,947

(22) PCT Filed: Sep. 29, 2006
(86) PCT No.: PCT/IB2006/053561

§ 371 Date: Apr. 11, 2008

(30) Foreign Application Priority Data
Oct. 12, 2005 (EP) 05109456.3

(51) Int. Cl. G01N 15/06

(52) U.S. Cl. 324/234

(57) ABSTRACT

The invention relates to a magnetic sensor device (10) comprising wires (11, 13) for the generation of a magnetic field with a first frequency f₁ a GMR sensor (12) operated with an input current of a second frequency f₂, and a demodulator (26) operated at a third frequency f₃. In order to avoid signal corruption by phase noise and to improve the signal-to-noise ratio, the first, second and third frequencies are derived by a supply unit (121) from a common reference frequency f_{ref}. Said derivation may for example be achieved with the help of digital frequency dividers. Furthermore, phase detectors (PD1, PD2) may be used in a feedback control loop to assure predetermined relations between the phases of the three frequencies. In another embodiment of the invention, the phase and/or amplitude of a model signal, which is used to process a desired signal component in the output of the sensor, is tracked by an adaptation algorithm, for example a gradient descent.

The invention relates to magnetic sensor devices comprising a magnetic field generator, a magnetic sensor element, and a detector module that are operated with different frequencies. Moreover, the invention relates to the use of such a magnetic sensor device and to methods for the detection of at least one magnetic particle with such magnetic sensor devices.

From the WO 2005/010543 A1 and WO 2005/010542 A2 a microsensor device is known which may for example be used in a microfluidic biosensor for the detection of biological molecules labeled with magnetic beads. The microsensor device is provided with an array of sensors comprising wires for the generation of a magnetic field and Giant Magneto Resistances (GMRs) for the detection of stray fields generated by magnetized beads. The signal of the GMRs is then indicative of the number of the beads near the sensor.

In the known magnetic sensor devices, the magnetic field is generated with a high first frequency f₁ in order to improve the signal-to-noise ratio (SNR) by avoiding 1/f noise, and the GMR sensor is operated with an alternating current of a second frequency f₂ that allows to separate parasitic crosstalk components from the desired magnetic signal in the GMR output. Furthermore, an input signal of a third frequency f₃ is needed for a demodulator that extracts the desired magnetic signal from the (amplified) GMR output. A problem of such a magnetic sensor device is that phase noise in any of the signals with the frequencies f₁, f₂, and f₃ decreases the signal-to-noise ratio.

Based on this situation it was an object of the present invention to provide means that allow a stable operation of a magnetic sensor device with a high signal-to-noise ratio.

This object is achieved by magnetic sensor devices according to claim 1 and to claim 8, a use according to claim 10, and methods according to claims 11 and 13. Preferred embodiments are disclosed the dependent claims.

A magnetic sensor device according to a first aspect of the present invention comprises the following components:

At least one magnetic field generator that is operated with an input signal (e.g. a current) of a first frequency f₁ and that is used for generating a magnetic field in an adjacent investigation region. The magnetic field generator may for example be realized by a wire on a substrate of a microsensor.

At least one magnetic sensor element that is operated with an input signal (e.g. a current) of a second frequency f₂ and that is associated with the aforementioned magnetic field generator in the sense that it is in the reach of effects caused by the magnetic field of the magnetic field generator. The magnetic sensor element may particularly be a magneto-resistive element of the kind described in the WO 2005/010543 A1 or WO 2005/010542 A2, especially a GMR, a TMR (Tunnel Magneto Resistance), or an AMR (Anisotropic Magneto Resistance).

At least one detector module, for example a demodulator, operated with an input signal of a third frequency f₃ for separating the desired signal component, which is related to the magnetic field generated by the magnetic field generator, in the output of the magnetic sensor element. Said output and the input signal of the detector module may for example be multiplied to generate a DC component proportional to the desired signal.

A reference generator for generating a reference signal (e.g. a voltage or a current) with a reference frequency f_{ref}.

A supply unit for deriving signals with the first frequency f₁, the second frequency f₂, and the third frequency f₃ from the aforementioned reference signal, the supply unit being coupled to the magnetic field generator, the magnetic sensor element, and the detector module for supplying them with the corresponding input signals.

An advantage of the described magnetic sensor device is that its supply unit derives all three required input signals with the different frequencies f₁, f₂, and f₃ from one common reference frequency f_{ref}. Frequency and phase drifts between the three input signals are therefore minimized, thus improving the signal-to-noise ratio and the stability of the magnetic sensor device significantly.

The supply unit is preferably designed such that there is a predetermined phase relation between the signals derived by it. The magnetic sensor device may particularly comprise a feedback control loop for controlling the supply unit in such a way that a predetermined phase relation is kept between at least two of the input signals of the magnetic field generator, the magnetic sensor element, and the detector module. Preferably, the feedback control loop is designed such that it keeps the predetermined phase relation between all said three input signals. It should be noted in this context that the input signals are by definition signals that prevail directly at the corresponding component (i.e. the magnetic field generator, magnetic sensor element, and detector module). These input signals are therefore usually separated from the corresponding output of the supply unit by intermediate hardware components (wires, resistances, amplifiers etc.) that may introduce phase noise (phase drift) between said output and the input signal, which affects the demodulated signal. By using the immediate input signals as reference variable of the control loop, such additional phase noise can thus be compensated.

In the aforementioned embodiment, the feedback control loop preferably comprises a phase detector for comparing the phases of two input signals. A difference in these phases can thus be detected and counteracted for by an appropriated control of the supply unit.

In another embodiment of the invention, the supply unit comprises at least one digital frequency divider that is fed with the reference signal. Digital frequency dividers are known in the state of the art in various embodiments. Their common feature is that they transform a signal with a frequency f_{ref} at their input into a signal with a frequency fₒᵤₜ at their output, wherein the output frequency fₒᵤₜ is a fraction of the input frequency f_{ref}. Digital frequency dividers have the advantage that the frequency ratio as well as the phase shift between their input and their output is very stable and can easily be selected via external control lines. The supply unit preferably comprises three such digital frequency dividers for generating all three frequencies f₁, f₂, and f₃ from the reference signal with frequency f_{ref}. In this case it is further preferred that at least two of the frequency dividers are internally synchronized with respect to their phase.

In the aforementioned embodiments, the supply unit may optionally comprise a driver unit that is coupled to the digital frequency divider and that transforms the output of said frequency divider into a desired waveform. According to a first realization, the driver circuit may comprise a band-pass filter that eliminates high frequency and DC components from the output of the frequency divider. According to a second realization, the driver circuit may comprise a look-up table, a combinatorial network or a high-speed microprocessor comprising a digital sample of the desired waveform and a digital-to-analog (DA) converter to convert the digital sample into an analog waveform.

According to a second aspect, the invention comprises a magnetic sensor device with the following components (wherein similar comments as with respect to the first aspect of the invention apply for identical entities):

a) at least one magnetic field generator operated with an input signal of a first frequency f₁;

b) at least one associated magnetic sensor element operated with an input signal of a second frequency f₂;

c) at least one detector module operated with a model signal of a third frequency f₃ for selectively processing a desired signal component, which is related to the operation of the magnetic field generator, in the output of the magnetic sensor element;

d) a tracking module for adjusting the model phase and/or the model amplitude of the model signal with respect to the phase of the desired signal component.

As was explained above, drift effects arising from temperature, ageing and the like will typically produce varying phase shifts in the (high-frequency) signals that are needed to operate the magnetic sensor device, wherein these phase shifts can significantly deteriorate the signal-to-noise ratio. A magnetic sensor device of the described kind avoids these disadvantages with the help of the phase tracking module that can compensate for any occurring phase shifts.

In a particular further development of the aforementioned embodiment, the tracking module is adapted to adjust the model phase and/or the model amplitude of the model signal via an optimization of a cost function that is determined from the desired signal component and the model signal. Particular examples for such a cost function will be described in more detail with reference to the Figures. The optimization may preferably be done with a gradient decent. In this case, it is usually possible to implement the necessary calculations in (analog) hardware as mainly the signals themselves and their derivatives are needed.

As its name shall indicate, the “model signal” often (but not necessarily) serves as a model or image of the (unknown) desired signal component. The cost function may therefore particularly be constructed as a measure of the difference between the desired signal component and the model signal, for example the squared difference between the corresponding values integrated over a time interval.

The approaches of the first and the second aspect of the present invention may favorably be combined. In this case, the usage of a common reference signal minimizes frequency and phase differences right at the source, while the tracking additionally compensates within the detector module any phase shifts that were introduced in the intermediate signal path.

The invention further relates to the use of the magnetic sensor devices described above for molecular diagnostics, biological sample analysis, or chemical sample analysis, particularly in body fluids (blood, saliva etc.) and cells. Molecular diagnostics may for example be accomplished with the help of magnetic beads that are directly or indirectly attached to target molecules.

A third aspect of the invention relates to a method for the detection of at least one magnetic particle, for example a magnetic bead attached to a label molecule, the method comprising the following steps:

Generating an alternating magnetic field with an input signal of a first frequency f₁ in the vicinity of a magnetic sensor element.

Operating the magnetic sensor element with an input signal of a second frequency f₂ and sensing a magnetic property of the magnetic particle that is related to the generated magnetic field.

Demodulating the output of the magnetic sensor element with an input signal of a third frequency f₃.

The method is characterized in that the mentioned input signals are derived from a common reference signal having a reference frequency f_{ref}.

The method comprises in general form the steps that can be executed with a magnetic sensor device according to the first aspect of the invention as it was described above. Therefore, reference is made to the preceding description for more information on the details, advantages and improvements of that method.

According to a preferred embodiment of the method, the phase relation between the input signals are locked by a feedback control loop. Thus a corruption of the measurements due to phase noise and phase drift can be prevented and the signal-to-noise ratio and the accuracy and stability can be improved accordingly.

A fourth aspect of the invention relates to a method for the detection of at least one magnetic particle which comprises the following steps:

Generating an alternating magnetic field with an input signal of a first frequency f₁ in the vicinity of a magnetic sensor element.

Operating the magnetic sensor element with an input signal of a second frequency f₂ and sensing a magnetic property of the magnetic particle that is related to the generated magnetic field.

Processing a desired signal component, which is related to the generated alternating magnetic field, in the output of the magnetic sensor element with the help of a model signal of a third frequency.

Adjusting the model of phase and/or the model amplitude of the model signal with respect to the phase of the desired signal component.

The method comprises in general form the steps that can be executed with a magnetic sensor device according to the second aspect of the invention as it was described above. Therefore, reference is made to the preceding description for more information on the details, advantages and improvements of that method.

In a preferred embodiment of the method, the adjustment of the model phase and/or the model amplitude is done by an optimization of a cost function that is determined from the desired signal component and the model signal.

These and other aspects of the invention will be apparent from and elucidated with reference to the embodiment(s) described hereinafter. These embodiments will be described by way of example with the help of the accompanying drawings in which:

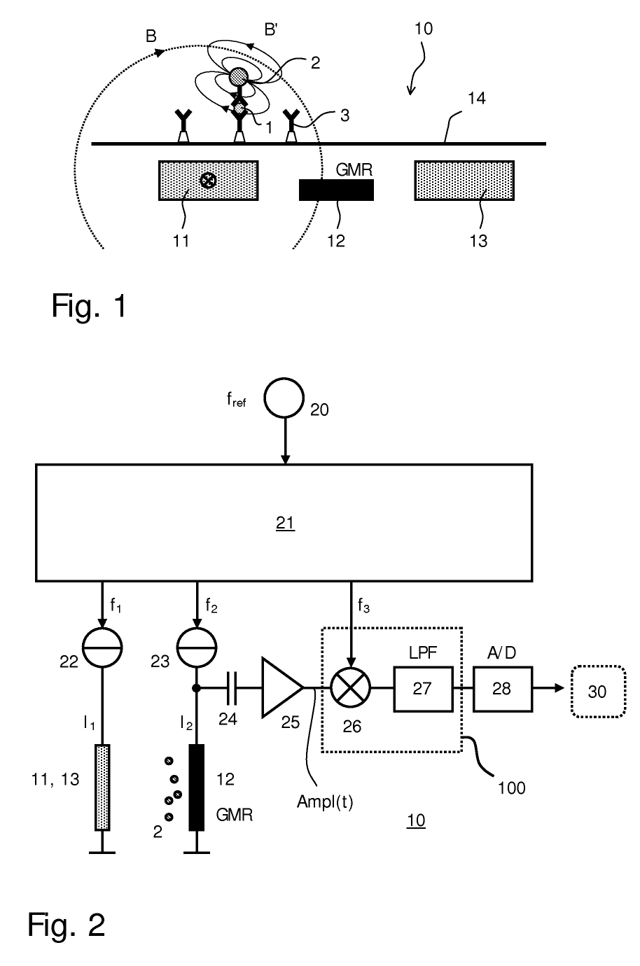

FIG. 1 illustrates the principle of a biosensor with a magnetic sensor device according to the present invention;

FIG. 2 depicts a block diagram of the circuitry of a magnetic sensor device according to the present invention;

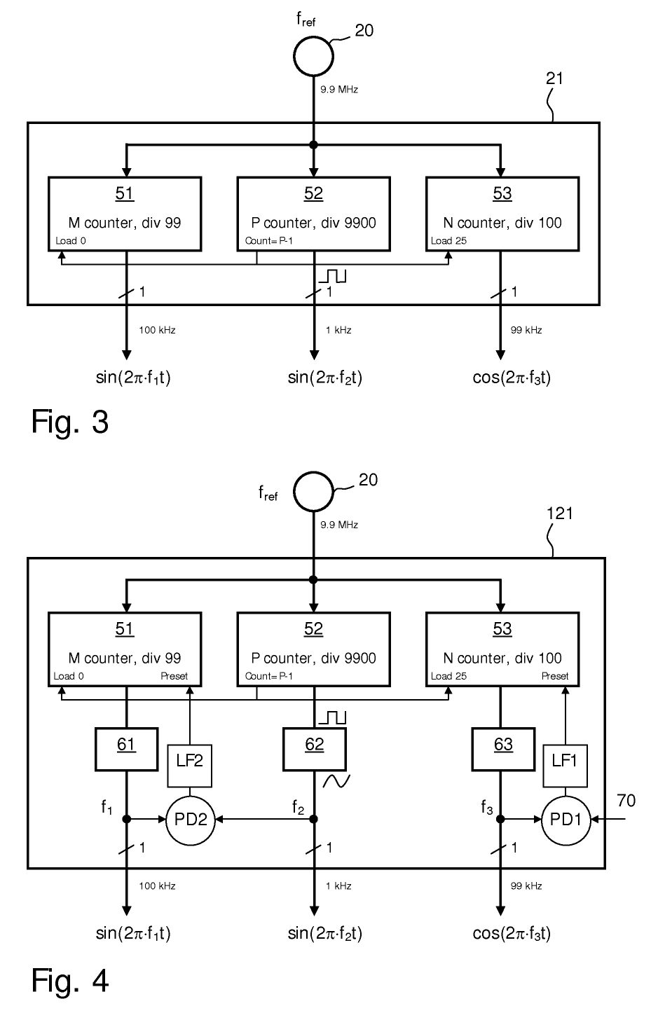

FIG. 3 shows a first, basic embodiment of a supply unit for the magnetic sensor device;

FIG. 4 shows a second embodiment of a supply unit that includes a phase feedback loop;

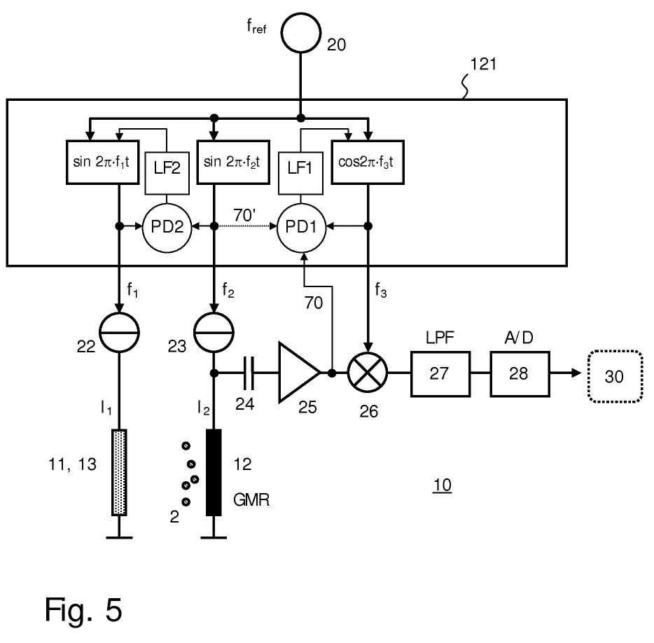

FIG. 5 illustrates the incorporation of the supply unit of FIG. 4 into the circuit of FIG. 3;

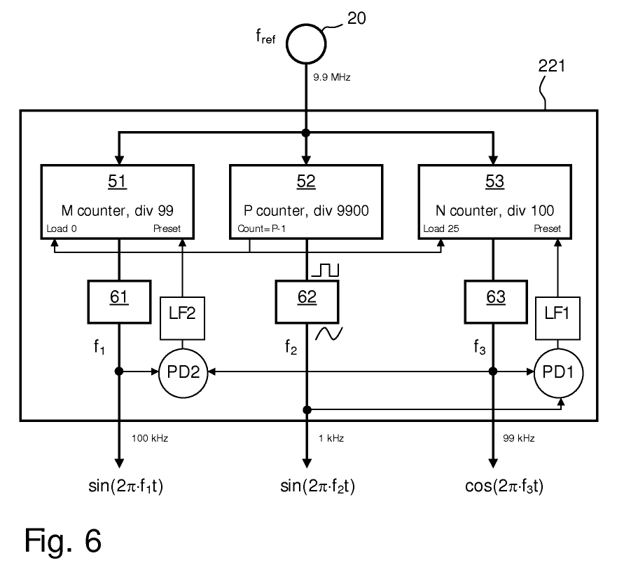

FIG. 6 shows a third embodiment of a supply unit with a phase feedback loop;

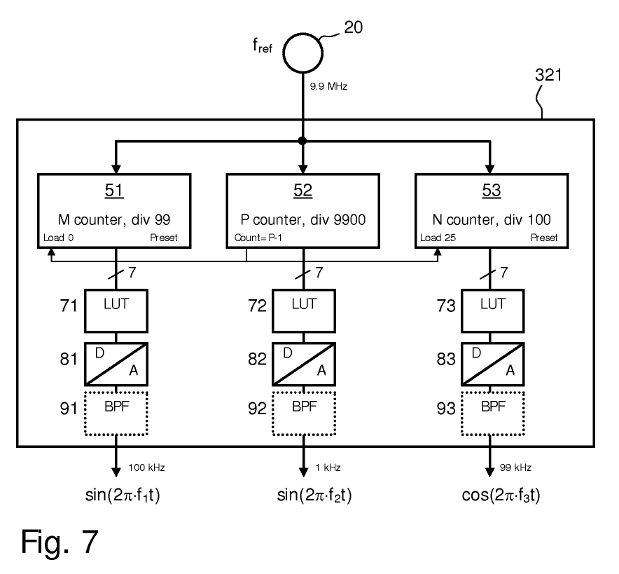

FIG. 7 shows a fourth embodiment of a supply unit with digital means for a waveform generation;

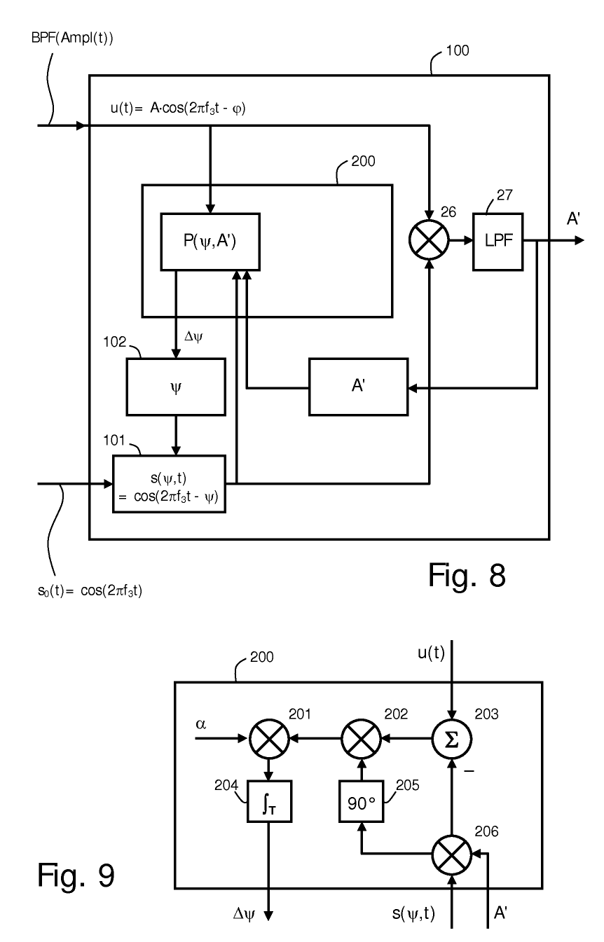

FIG. 8 shows the general design of a detector module that comprises a tracking module for tracking the phase of a model signal used for the demodulation of the sensor output;

FIG. 9 shows a particular realization of the tracking module in the design of FIG. 8;

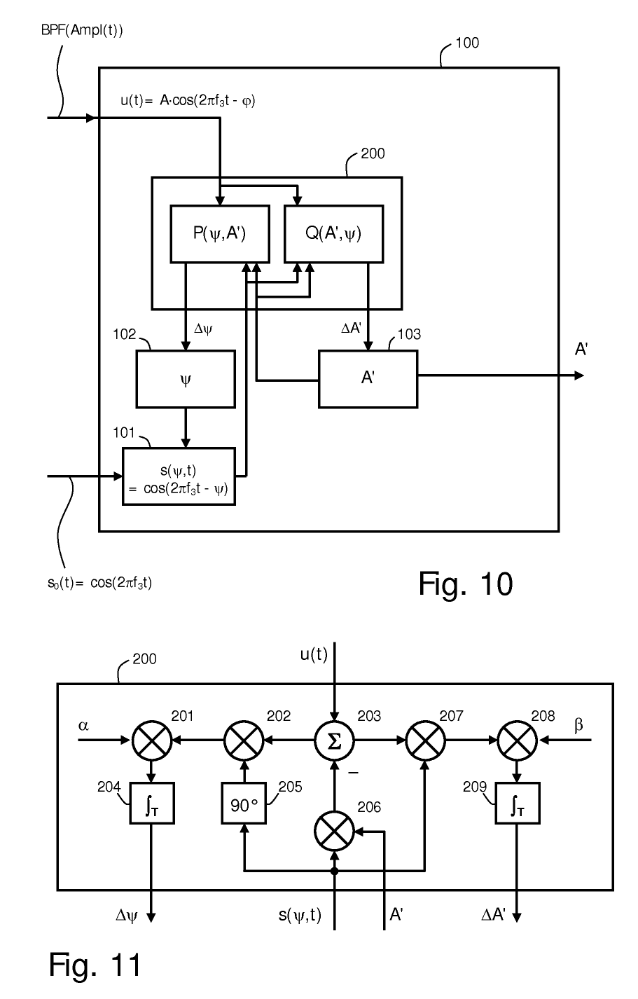

FIG. 10 shows a variant of FIG. 8, in which also the amplitude of the model signal is tracked;

FIG. 11 shows a particular realization of the tracking module in the design of FIG. 10;

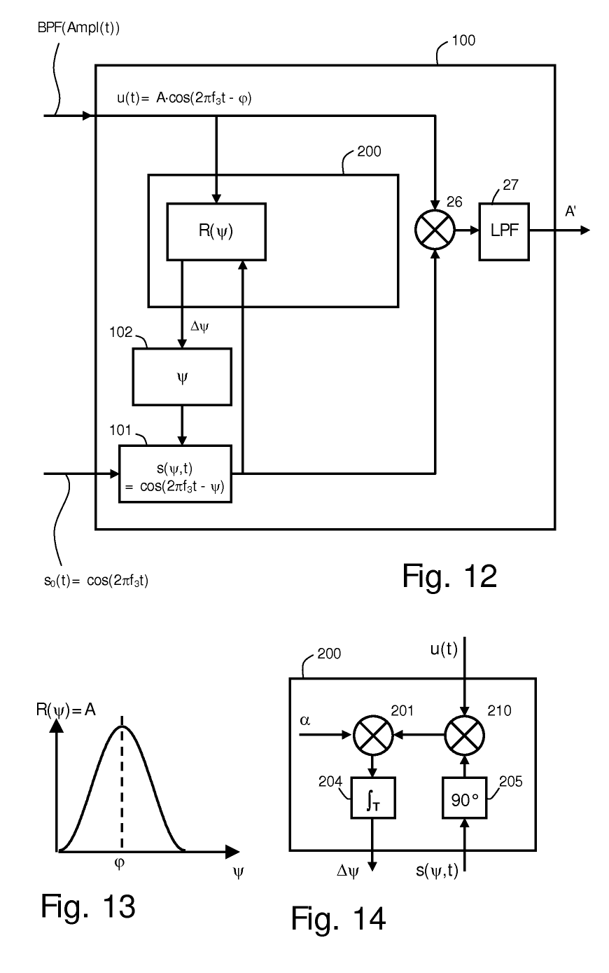

FIG. 12 shows a further variant of FIG. 8, in which a cost function is used that is independent of the amplitude of the model signal;

FIG. 13 shows schematically the cost function of FIG. 12;

FIG. 14 shows a particular realization of the tracking module in the design of FIG. 12.

Like reference numbers in the Figures refer to identical or similar components.

Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

FIG. 1 illustrates the principle of a single magnetic sensor device 10 for the detection of superparamagnetic beads 2. A biosensor consisting of an array of (e.g. 100) such sensor devices 10 may be used to simultaneously measure the concentration of a large number of different biological target molecules 1 (e.g. protein, DNA, amino acids) in a solution (e.g. blood or saliva). In one possible example of a binding scheme, the so-called “sandwich assay”, this is achieved by providing a binding surface 14 with first antibodies 3, to which the target molecules 1 may bind. Superparamagnetic beads 2 carrying second antibodies may then attach to the bound target molecules 1. A current flowing in the wires 11 and 13 of the sensor 10 generates a magnetic field B, which then magnetizes the superparamagnetic beads 2. The stray field B′ from the superparamagnetic beads 2 introduces an in-plane magnetization component in the Giant Magneto Resistance (GMR) 12 of the sensor device 10, which results in a measurable resistance change.

FIG. 2 shows the schematic block diagram of a circuitry that can be used in connection with the magnetic sensor device 10 of FIG. 1. Said circuitry comprises a current source 22 that is coupled to the conductor wires 11, 13 to provide them with a generator current I₁. Similarly, the GMR 12 is coupled to a second current source 23 that provides the GMR 12 with a sensor current I₂. The signal of the GMR 12, i.e. the voltage drop across its resistance, is sent via an optional high pass filter (capacitor 24), an amplifier 25, a demodulator 26, a low pass filter 27, and an analog-to-digital (AD) converter 28 to the output 30 of the sensor device for final processing (e.g. by a personal computer). The demodulator 26 and the low pass filter 27 can be seen as one exemplary realization of a detector module 100 that selectively processes and/or separates a desired signal component in the (pre-processed) GMR output.

The generator current I₁ is modulated with a first frequency f₁, the sensor current I₂ is modulated with a second frequency f₂, and the input to the demodulator 26 has a frequency f₃. The frequency f₁ of the magnetic excitation field is chosen such that the 1/f noise and instability regime of the GMR sensor 12 is avoided, for example f₁≧1 MHz. By modulating the GMR sensor current by a frequency f₂≠0 Hz it is possible to distinguish between the parasitic (inductive and capacitive) crosstalk components and the desired magnetic signal by synchronous demodulation as will be explained in more detail in the following. Assuming the signals to be sinusoidal waves, the generator and the sensor currents become:

I₁=I_{1,0}·sin(2π·f₁t),

I₂=I_{2,0}·sin(2π·f₂t).

The high frequency current I₁ in the wires 11, 13 induces a magnetic field in the GMR 12. Because of the fact that the GMR sensor is exclusively sensitive to magnetic fields, only the magnetic component (and not the parasitic crosstalk) of the measurement signal of the sensor 12 is multiplied by the sensor current I₂. After amplification in the amplifier 25, the amplified signal Ampl(t) therefore becomes:

$$\begin{matrix}Amp 1 ( t ) = μ N \cdot [ {I}_{1 , 0} \cdot sin ( 2 π \cdot {f}_{1} t ) ] \cdot [ {I}_{2 , 0} \cdot sin ( 2 π \cdot {f}_{2} t ) ] + \\ σ \cdot {I}_{1 , 0} \cdot sin ( 2 π \cdot {f}_{1} t ) + τ \cdot {I}_{2 , 0} \cdot sin ( 2 π \cdot {f}_{2} t ) \\ = \frac{1}{2} μ N \cdot {I}_{1 , 0} {I}_{2 , 0} \cdot [ \begin{matrix}cos 2 π \cdot ( {f}_{1} - {f}_{2} ) t - \\ cos 2 π \cdot ( {f}_{1} + {f}_{2} ) t\end{matrix} ] + \\ σ \cdot {I}_{1 , 0} \cdot sin ( 2 π \cdot {f}_{1} t ) + τ \cdot {I}_{2 , 0} \cdot sin ( 2 π \cdot {f}_{2} t ) ,\end{matrix} \qquad ( 1 )$$

wherein N is the number of magnetic beads 2 in the vicinity of the GMR 12, μ is a proportionality factor, σ is a constant related to the capacitive and inductive crosstalk between the wires 11, 13 and the GMR 12, and τ is a constant (the GMR resistance) related to the sensor voltage induced by the sensor current I₂ in the GMR 12. The formula shows that multiplication of Ampl(t) with a signal cos 2π(f₁±f₂) in the demodulator 26 will extract a DC signal proportional to the desired number N (i.e. the value for f₃ is f₁+f₂ or f₁−f₂).

A problem of the described approach is that phase noise on any of the input signals to the wires 11, 13, the GMR sensor 12, and the demodulator 26 at frequencies f₁, f₂, or f₃ decreases the detection SNR of the biosensor. Furthermore, as the received magnetic signal SNR may be low, frequency and phase locking of f₃ to the magnetic signal may introduce extra noise. Generating said input signals of frequencies f₁, f₂, f₃ from Phase-Locked-Loop (PLL) circuitry requires three Voltage-Controlled-Oscillators (VCOs), which is complicated and difficult to integrate on an IC. Therefore, a magnetic sensor device 10 is required that has a high detection SNR, a high stability, and an easy adjustable (excitation) frequency f₁, while being easy to realize in discrete components (minimal components) and on an IC.

According to a first proposed solution to this objective, the excitation-, sense- and detection input signals with frequencies f₁, f₂, and f₃ are derived in a supply unit 21 from the frequency f_{ref} of a single reference generator 20, in such a way that the phase noise between said signals is minimized. As a result phase noise or frequency drift in the reference generator 20 does not affect the detection SNR. As will be explained below in more detail, low-bandwidth PLL or DLL (Delay-Locked-Loop) circuitry may be added to the supply unit 21 practically without SNR degradation to optimize only the phase and not the frequency of the signals; this measure is feasible because (1) the frequencies f₁, f₂, f₃ are well defined and (2) their phase relation varies only slowly, e.g. by temperature and component tolerances. Furthermore, the amount of phase shifting components can be minimized by digitally generating the required waveforms, which avoids temperature and component tolerance dependent detector behavior and eases discrete and integrated implementation.

A first embodiment of a supply unit 21 comprising digital dividers and generating square wave signals is sketched in FIG. 3. The reference frequency f_{ref} from the frequency generator 20 is divided by three synchronized digital frequency dividers 51, 52, and 53, which are realized by an M counter, P counter, and N counter, respectively. The P counter 52, which generates the lowest frequency f₂, synchronizes the phase of the two other frequency dividers 51 and 53. By presetting the N counter 53 to 25, a 90-degrees phase shift is introduced for generating a cosine.

Band-pass filters may be added to remove DC and higher harmonics in the divider output signals (cf. components 61, 62, 63 in FIG. 4). Due to unequal phase/delay in the band-pass filters and signal paths, the phase relation between the signals will deviate from optimal. This effect may be compensated by adjusting the counter preset mechanism accordingly, e.g. by changing the load values in the M and N counters.

A second embodiment of a supply unit 121 that maintains optimal phase relations is shown in FIG. 4. Components that are identical to those of FIG. 3 have the same reference numbers and will not be explained again. FIG. 4 shows three drivers 61, 62, and 63 that are coupled to the counters 51, 52, and 53, respectively, for transforming their square wave outputs into other waveforms. The drivers 61, 62, 63 typically comprise high order band-pass filtering means to generate non-square wave shaped signals, e.g. sine waves.

The optimum phase relation between the signals may vary due to temperature changes, drift and tolerances of electrical components. For example drift of the reference frequency generator 20 may introduce un-equal phase shifts in the three driver blocks 61-63. This effect may be compensated by adaptive feedback of said phase relation by using a Phase-Lock-Loop or Delay-Locked-Loop system and e.g. control the preset value of the counters 51-53. In this approach the phase relations should be determined at a point as close as possible near the sensor, e.g. the phase corresponding to f₁ at the input of the field-generating wires 11, 13, the phase corresponding to f₂ across the GMR sensor 12, and the demodulation frequency f₃ at the input of the synchronous demodulator 26. Then said phases are compared by phase detectors PD1 and PD2, respectively, and adjusted to the optimal value by varying the “Preset” values of the accompanying dividers via loop filters LF1 and LF2, respectively. It should be noted in this respect that a phase detector is assumed to determine a phase error with respect to the transitions of the lowest frequency if two different frequencies are compared.

FIG. 5 shows the integration of the supply unit 121 described above into a magnetic sensor device 10 according to FIG. 2, wherein the counters 51-53 and the drivers 61-63 have been lumped together in one block. In a first embodiment, the phase detector PD 1 compares the input signal of frequency f₃ right before the demodulator 26 with a signal 70 derived between amplifier 25 and demodulator 26. In case the phase/delay in the amplifier 25 (and potential further processing means between the GMR 12 and the demodulator 26) is well defined, a second embodiment may be chosen that uses the dotted connection 70′ to frequency f₂ instead of line 70.

It should be noted that in the previous examples (besides in the case of using line 70′) the phase detectors PD 1 and PD2 generate both zero for zero degrees phase difference. This may be avoided by using the third embodiment of a supply unit 221 shown in FIG. 6. In contrast to FIG. 4, here both phase detectors PD1, PD2 output zero when the phase difference equals 90 degrees.

FIG. 7 shows a fourth embodiment of a supply unit 321 with digital dividers 51-53 and a generation of non-square wave signals. In order to avoid analog circuitry (e.g. higher-order filters, waveform shaping non-linear circuits etc.) to generate alternative waveforms like sine and triangle, digital-to-analog Converters (DACs) 81, 82, 83 may be added, which via look-up tables LUT 71, 72, 73, combinatorial networks (gate-arrays) or high-speed microprocessors generate the desired waveforms from the counter-bits. By repeatedly counting up and down and by converting the counter bits to the analog domain with the DACs, a triangle wave may alternatively be generated without look-up tables; the resulting wave approaches a sine wave or may be converted to a sine wave by moderate order filtering. Optionally low-order band-pass filters 91, 92, 93 may be added to remove DC and frequency components above half the reference frequency (the Nyquist frequency). As a consequence phase shifts due to temperature and component tolerances are avoided, so that phase adjusting means may be omitted. By varying the reference frequency f_{ref}, alternative excitation frequencies may be generated without the need to tune analog filters.

While an important feature of the previously described embodiments was the use of a common reference signal of frequency f_{ref} for the generation of the excitation current of frequency f₁, the sensor current of frequency f₂, and the demodulator signal of frequency f₃, the variants of the invention that will be described in the following will concentrate on the processing of signals in a detector module. For these embodiments, the generation of the frequencies f₁, f₂, and f₃ may in principle be done in any suitable way, though the previously described derivation from a common reference frequency is preferred as it guarantees minimal frequency and phase shifts at the source of signal generation.

FIG. 8 shows a principal sketch of a first kind of detector module 100. The detector module 100 receives as one input the measurement signal from the GMR sensor, wherein it will be assumed in the following that, for example by a suited band pass filtering BPF, this input will effectively only comprise the “desired signal component” u(t) according to (cf. equation (1)):

$$\begin{matrix}u ( t ) = BPF ( Amp 1 ( t ) ) \\ = \frac{1}{2} μ N \cdot {I}_{1 , 0} {I}_{2 , 0} \cdot cos ( 2 π \cdot ( {f}_{1} - {f}_{2} ) t - ϕ ) \\ = A \cdot cos ( 2 π {f}_{3} t - ϕ )\end{matrix} \qquad ( 2 )$$

This desired signal component u(t) comprises as amplitude A the value of interest and has a frequency f₃ which is assumed to be the difference f₃=(f₁−f₂) here. A phase φ was introduced in this formula to take account of an unknown, typically time-varying phase shift.

Moreover, the detector module 100 receives as input the “basic model signal”

s₀(t)=cos(2πf₃t)

of frequency f₃, wherein the term “basic” shall indicate that is signal has an amplitude of 1 and no phase shift at this stage.

The task of the detector module 100 is to provide at its output the “model amplitude” A′ that is an estimation for the amplitude A of the desired signal component u(t) according to equation (2).

As was already described above (cf. FIG. 2), the detector module 100 may perform its function by demodulating the desired signal component u(t) in a demodulator 26 with the basic model signal s₀(t) and a subsequent filtering in a low pass filter 27. In reality, there will however be a phase difference between the desired signal component u(t) and the basic model signal s₀(t) due to the non-zero phase (φ≠0. The consequences of this phase difference on the output value A′ can be calculated as follows, wherein it is assumed that the basic model signal s₀(t) is provided with an adjustable “model phase” ψ in a delay unit 101 (yielding the “model signal” s(ψ, t)) and wherein LPF denotes the low pass filtering and a multiplication with factor 2:

$$\begin{matrix}{A}^{′} = LPF [ A \cdot cos ( 2 π {f}_{3} t - ϕ ) \cdot cos ( 2 π {f}_{3} t - ψ ) ] \\ = LPF [ \frac{1}{2} A ( cos ( ϕ - ψ ) + cos ( 4 π {f}_{3} t - ϕ - ψ ) ]\end{matrix} \\ {A}^{′} = A \cdot cos ( ϕ - ψ ) \qquad ( 3 )$$

The DC component of the demodulator output is therefore directly proportional to the amplitude A (i.e. the amount N of beads one is interested in), but is also related to the phase difference (φ−ψ) between the sensor signal u(t) and the model signal s(ψ,t). This phase difference changes with time and may in practice cause variations in the output signal A′ of up to about 20%, which exceed the RMS voltage of the additive thermal noise in a 1 Hz bandwidth detection system. Obviously, phase variations give thus rise to uncorrectable measurement errors and degradation of the overall system performance.

In order to minimize the negative effects of phase shifts, the detector module 100 comprises a “tracking module” 200 which receives in the embodiment of FIG. 8 as input:
the desired signal component u(t),
the phase shifted model signal s(ψ,t), and
the model amplitude A′.

Based on these inputs, the tracking module 200 performs a gradient descent with respect to the model phase ψ and an appropriately defined cost function P(ψ, A′). The determined gradient step Δψ is then used to adjust in a unit 102 the present model phase ψ, which is further introduced by the delay unit 101 as phase shift into the basic model signal s₀. The aim of the tracking module 200 is then to keep the phase difference constant, typically at (φ−ψ)=0, which yields definite results for the model amplitude A′ in equation (3).

FIG. 9 shows a particular realization of the tracking module 200. This realization is based on a cost function P(ψ,A′) that is defined by the integrated squared “error signal” e(ψ, A′, t), i.e. the difference between the desired signal component u(t) on the one hand side and the model signal s(ψ,t) multiplied with the model amplitude A′ on the other hand side:

$$\begin{matrix}P ( ψ , {A}^{′} ) = 1 / T \cdot {\int }_{T} {( e ( ψ , {A}^{′} , t ) )}^{2} d T \\ = 1 / T \cdot {\int }_{T} {( u ( t ) - {A}^{′} \cdot s ( ψ , t ) )}^{2} d t\end{matrix} \qquad ( 4 )$$

Integration is performed here over an interval T of one period, T=1/f₃, or multiples thereof. According to the well-known class of gradient descent algorithms, the updated phase ψ_{new} is calculated according to

ψ_{new}=ψ_{old}−α·∂P/∂ψ (5)

wherein α>0 is an appropriately chosen constant. Using equation (4) yields for the partial derivation:

$$\frac{\partial P}{\partial ψ} = \frac{2}{T} {\int }_{T} d t \cdot e ( ψ , {A}^{′} , t ) \cdot \frac{\partial }{\partial ψ} e ( ψ , {A}^{′} , t ) = … = - \frac{2}{T} {\int }_{T} d t \cdot e ( ψ , {A}^{′} , t ) \cdot {A}^{′} \cdot sin ( 2 π {f}_{3} t - ψ ) \qquad ( 6 )$$

It should be noted that, when deriving this formula, use was made of the fact that the integral of a sin or cos function over one period T is zero.

The implementation of this gradient-based phase tracking algorithm as a first order phase locked loop is depicted in FIG. 9. The outputs of the shown units of the phase tracking module 200 are as follows:
modulator 206: product A′·s(ψ, t)=A′·cos(2πf₃t−ψ);
adder 203: error signal e(ψ, A′, t)=u(t)−A′·s(ψ, t);
phase shifter 205: A′sin(2πf₃t−ψ);
modulator 202: product A′sin(2πf₃t−ψ)·e(ψ, A′, t);
modulator 201: product α·A′sin(2πf₃t−ψ)e(ψ, A′, t);
integrator 204: α·∂P/∂ψ according to equation (6) (besides constant factors).

It should be noted that the cascade of the integrator 204, the variable delay unit 101, and the oscillator generating so(t) (not shown) could be replaced by a voltage controlled oscillator.

Instead of tracking the phase φ and then demodulating the sensor signal u(t) to obtain the model amplitude A′, as proposed in the previous embodiment, one can also jointly track the phase φ and the amplitude A of the desired output signal u(t). The general layout for this approach is shown in FIG. 10. Components that are the same as in FIG. 8 need not be described again. An important difference is the fact that the tracking module 200 now comprises a second cost function Q(A′, ψ) that is, similar to the already introduced cost function P(ψ, A′), used for a gradient descent, but now with respect to the variable A′. The model amplitude A′ that is managed and provided by a unit 103 will then directly contain the output result of the detector module 100.

FIG. 11 shows a particular realization of the tracking module 200, wherein the same cost functions are used for tracking v and A′, i.e. P(ψ, A′)=Q(A′, ψ). The updated model amplitude A′_{new} is calculated according to

A′_{new}=A′_{old}−β·∂P/∂A′ (7)

wherein β>0 is an appropriately chosen constant. Using equation (4) yields for the partial derivation:

$$\frac{\partial P}{\partial {A}^{′}} = \frac{2}{T} {\int }_{T} d t \cdot e ( ψ , {A}^{′} , t ) \cdot \frac{\partial }{\partial {A}^{′}} ( e ( ψ , {A}^{′} , t ) ) = … = - \frac{2}{T} {\int }_{T} d t \cdot e ( ψ , {A}^{′} , t ) \cdot cos ( 2 π {f}_{3} t - ψ ) \qquad ( 8 )$$

The left hand part of the tracking module in FIG. 11, which calculates the model phase update Δψ, is the same as in FIG. 9 (besides a factor A′). In the right hand part, the outputs of the shown units are as follows:
modulator 207: product e(ψ, A′, t)·s(ψ, t)=e(ψ, A′, t)·cos(2πf₃t−ψ);
modulator 208: product β·e(ψ, A′, t)·cos(2πf₃t−ψ);
integrator 209: β·∂P/∂A′ according to equation (8) (besides constant factors).

It can be seen that a gain estimator has been added in the closed-loop of the system, such that the model signal A′s(ψ, t) accurately approximates the sensor signal u(t).

As an alternative to a phase tracking based on error minimization, as it was used in the previous embodiments, the model signal s(ψ, t) and the sensor signal u(t) can also be synchronized by maximizing the model amplitude A′ at the output of the detector module 100 that is calculated by the demodulation of the sensor signal u(t) with the model signal s(ψ, t). According to equation (3), this model amplitude can be expressed as

A′=R(ψ)=A/T·∫_{T}dt·cos(φ−ψ). (9)

The low pass filtering LPF of equation (3) has been replaced here by a normalized integration of the signal over (a multiple of) the period T=1/f, which yields the same effect. As shown in FIG. 13, the cost function R(ψ), i.e. the model amplitude A′, has a single maximum at ψ=φ on the fundamental interval (−π<ψ<π). A gradient-based algorithm can therefore again be constructed based on the model amplitude A′ that adaptively tracks the phase according to

ψ_{new}=ψ_{old}+α·∂R/∂ψ=ψ_{old}+α·A/T·∫_{T}dt·sin(φ−ψ), (10)

wherein the + sign reflects the fact that now the maximum (instead of the minimum) of a cost function R is looked for.

FIG. 12 shows the general layout of a detector module 100 for the aforementioned approach, while FIG. 14 depicts the associated tracking module 200. The outputs of the units in the tracking module 200 are as follows:
phase shifter 205: sin(2πf₃t−ψ);
modulator 210: u(t)·sin(2πf₃t−ψ)=A/2·(sin(4πf₃t−φ−ψ)−sin(ψ−φ));
modulator 201: α·(A/2·(sin(4πf₃t−φ−ψ)−sin(ψ−φ)));
integrator 204: α·∂R/∂ψ according to equation (10) (besides constant factors).

The magnetic sensor devices described above have the following advantages:
High detection SNR by minimizing the phase noise between excitation-, sense- and detection signals.
High stability due to minimal phase design by using a minimal amount of phase shifting components in the signal paths of the detector.
Easy to realize using discrete components, no complicated high-order band-pass filters required.
Easy to integrate on an IC.

The invention is however not limited to the embodiments explicitly mentioned. Alternative dividing ratios, signal shapes (square, triangle, sine etc.), frequencies and combinations of the shown embodiments are part of the invention. Furthermore this invention may be particularly used to detect bio-chemical molecules in blood, saliva, in body fluids and in cells.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A magnetic sensor device (10), comprising
a) at least one magnetic field generator (11, 13) operated with an input signal of a first frequency f₁;
b) at least one associated magnetic sensor element (12) operated with an input signal of a second frequency f₂;
c) at least one detector module (26, 100) operated with an input signal of a third frequency f₃ for separating a desired signal component, which is related to the operation of the magnetic field generator (11, 13), in the output of the magnetic sensor element (12);
d) a reference generator (20) for generating a reference signal with a reference frequency f_{ref};
e) a supply unit (21, 121, 221, 321) for deriving signals with the first, the second, and the third frequency from the reference signal and for supplying them to the magnetic field generator (11, 13), the magnetic sensor element (12), and the detector module (26), respectively.

2. The magnetic sensor device (10) according to claim 1,
characterized in that it comprises a feedback control loop for controlling the supply unit (121, 221) such that a predetermined phase relation is kept between at least two of the input signals of the magnetic field generator (11, 13), the magnetic sensor element (12) and the detector module (26).

3. The magnetic sensor device (10) according to claim 2,
characterized in that the feedback control loop comprises a phase detector (PD1, PD2) for comparing the phases of two input signals.

4. The magnetic sensor device (10) according to claim 1,
characterized in that the supply unit (21, 121, 221, 321) comprises at least one digital frequency divider (51, 52, 53) that is fed with the reference signal.

5. The magnetic sensor device (10) according to claim 4,
characterized in that the supply unit (21, 121, 221, 321) comprises a driver circuit (61, 62, 63; 71, 72, 73; 81, 82, 83) for transforming the output of the frequency divider (51, 52, 53) into a predetermined waveform.

6. The magnetic sensor device (10) according to claim 5,
characterized in that the driver circuit comprises a band-pass filter (61, 62, 63).

7. The magnetic sensor device (10) according to claim 5,
characterized in that the driver circuit comprises a look-up table (71, 72, 73), a combinatorial network, or a high-speed microprocessor and a digital-to-analog converter (81, 82, 83).

8. A magnetic sensor device (10), comprising
a) at least one magnetic field generator (11, 13) operated with an input signal of a first frequency f₁;
b) at least one associated magnetic sensor element (12) operated with an input signal of a second frequency f₂;
c) at least one detector module (100) operated with a model signal (s(ψ,t)) of a third frequency f₃ for selectively processing a desired signal component (u(t)), which is related to the operation of the magnetic field generator (11, 13), in the output of the magnetic sensor element (12);
d) a tracking module (200) for adjusting the model phase (ψ) and/or the model amplitude (A′) of the model signal with respect to the phase (φ) of the desired signal component.

9. The magnetic sensor device (10) according to claim 8,
characterized in that the tracking module (200) is adapted to adjust the model phase (ψ) and/or the model amplitude (A′) via an optimization of a cost function (P, Q, R) that is determined from the desired signal component (u(t)) and the model signal (s(ψ,t)).

10. Use of the magnetic sensor device (10) according to claim 1 for molecular diagnostics, biological sample analysis, or chemical sample analysis.

11. A method for the detection of at least one magnetic particle (2), the method comprising the following steps:
generating an alternating magnetic field (B) with an input signal of a first frequency f₁ in the vicinity of a magnetic sensor element (12);
operating the magnetic sensor element (12) with an input signal of a second frequency f₂ and sensing a magnetic property of the magnetic particle (2) that is related to the generated magnetic field (B),
demodulating the output of the magnetic sensor element (12) with an input signal of a third frequency f₃,
wherein said input signals are derived from a common reference signal having a reference frequency f_{ref}.

12. The method according to claim 11, characterized in that the phase relations between the input signals are locked by a feedback control loop.

13. A method for the detection of at least one magnetic particle (2), the method comprising the following steps:
generating an alternating magnetic field (B) with an input signal of a first frequency f₁ in the vicinity of a magnetic sensor element (12);
operating the magnetic sensor element (12) with an input signal of a second frequency f₂ and sensing a magnetic property of the magnetic particle (2) that is related to the generated magnetic field (B),
processing a desired signal component (u(t)), which is related to the magnetic field (B), in the output of the magnetic sensor element (12) with the help of a model signal (s(ψ,t)) of a third frequency f₃;
adjusting the model phase (ψ) and/or the model amplitude (A′) of the model signal with respect to the phase (φ) of the desired signal component.

14. The method according to claim 13,
characterized in that the adjustment is done by an optimization of a cost function (P, Q, R) that is determined from the desired signal component (u(t)) and the model signal (s(ψ,t)).
